(19) United States
(12) Patent Application Publication
(10) Pub. No.: US 2007/0190381 A1
(43) Pub. Date: Aug. 16, 2007

(54) Solid oxide fuel cell electric power generation apparatus

(75) Inventors: Michio Horiuchi, Nagano (JP); Yasue Tokutake, Nagano (JP); Shigeaki Suganuma, Nagano (JP); Jun Yoshiike, Nagano (JP); Fumimasa Katagiri, Nagano (JP)

Correspondence Address: DRINKER BIDDLE & REATH (DC), 1500 K STREET, N.W., SUITE 1100, WASHINGTON, DC, 20005-1209, US

(73) Assignee: SHINKO ELECTRIC INDUSTRIES CO., LTD.

(21) Appl. No.: 11/605,339

(22) Filed: Nov. 29, 2006

(30) Foreign Application Priority Data
Nov. 30, 2005 (JP) P. 2005-346401

(51) Int. Cl. H01M 8/04; H01M 8/12

(52) U.S. Cl. 429/26; 429/31

(57) ABSTRACT

The electric power generation apparatus of the invention has a solid oxide fuel cell C3 comprising a cathode electrode layer 2 formed on the outer side of a hollow solid electrolyte substrate 1, an anode electrode layer 3 formed on the inner side of the substrate and an inner space defined by the anode electrode layer and a gas burner 4 for generating flame f provided at the lower end of the inner space. A metallic mesh 5 is disposed at the lower part of the inner space to retain a solid fuel F introduced. The solid fuel F is put into gas phase by flame F as a heat source to produce a fuel seed. The fuel seed is supplied directly into the anode electrode layer surrounding the inner space.

### BACKGROUND OF THE INVENTION

1. Field of the Invention

The present invention relates to an electric power generation apparatus utilizing a solid oxide fuel cell. More particularly, the present invention relates to an electric power generation apparatus utilizing a solid oxide fuel cell, in which a solid fuel is introduced into an interior of a solid oxide fuel cell comprising a hollow solid electrolyte substrate having a cathode electrode layer formed on the outer side thereof and an anode electrode layer formed on the inner side thereof and is arranged so simply as to require no sealing, making it possible to put the solid fuel in gas phase that can be used as a fuel for the fuel cell to generate electricity.

2. Description of Related Art

In recent years, fuel cells of various types of electric power generation apparatus have been developed. Among these types of fuel cells, there is a solid oxide fuel cell of the type having a solid electrolyte. As an example of the fuel cell having the solid electrolyte, there is provided a one employing a sintered material made of stabilized zirconia to which an yttria (Y₂O₃) is added as an oxygen-ionically conductive solid electrolyte substrate. A cathode electrode layer is formed on one side of the solid electrolyte substrate while an anode electrode layer is formed on the other side of the solid electrolyte substrate. Oxygen or an oxygen-containing gas is supplied into the fuel cell on the cathode electrode layer side thereof while a fuel gas such as methane is supplied into the fuel cell on the anode electrode layer side thereof.

In this fuel cell, oxygen (O₂) which has been supplied into the cathode electrode layer is ionized to oxygen ion (O²⁻) at an interface between the cathode electrode layer and the solid electrolyte substrate. The oxygen ion is conducted through the solid electrolyte substrate to the anode electrode layer where it reacts with the supplied gas such as methane (CH₄) to produce water (H₂O), carbon dioxide (CO₂), hydrogen (H₂) and carbon monoxide (CO). In this-reaction, oxygen ion releases electron to make some difference in potential between the cathode electrode layer and the anode electrode layer. Accordingly, when a lead wire is attached to the cathode electrode layer and the anode electrode layer so that electron in the anode electrode layer flows through the lead wire toward the cathode electrode layer, electric power is generated by a fuel cell. The driving temperature of the fuel cell is about 1,000° C.

However, this type of a fuel cell requires separate type chambers. That is, a chamber for an oxygen or oxygen-containing gas is required at the cathode electrode layer side and another chamber for a fuel gas is required at the anode electrode layer side thereof. Further, since this type of a fuel cell is exposed to an oxidizing atmosphere and a reducing atmosphere at high temperatures, it is difficult to enhance the durability of fuel cell unit.

On the other hand, a fuel cell has been developed which has a cathode electrode layer and an anode electrode layer provided on the opposing sides the solid electrolyte substrate, respectively, to form a fuel cell unit that is disposed in a fuel gas such as mixture of methane gas and oxygen gas to cause the generation of electromotive force between the cathode electrode layer and the anode electrode layer. The principle of this type of a fuel cell in the generation of electromotive force between the cathode electrode layer and the anode electrode layer is the same as that of the aforementioned separate chamber type fuel cell. However, since this structure has advantageous in that the solid oxide fuel cell can be entirely disposed in substantially the same atmosphere, it can be in the form of a single chamber to which a mixed fuel gas is supplied. Thus, it becomes possible to enhance the durability of the fuel cell.

However, the electric power generation apparatus of this single chamber type fuel cell, too, must be driven at a temperature as high as about 1,000° C. Thus, there is a risk of explosion of mixed fuel gas. When lowering the oxygen concentration the flammability limit to avoid this risk, the carbonation of the fuel such as methane proceeds, raising a problem of deterioration of cell performance. In order to solve this problem, a single chamber type fuel cell has been proposed which can employ a mixed fuel gas in an oxygen concentration allowing prevention of explosion of mixed fuel gas as well as prevention of progress of carbonation of fuel (see Japanese Patent Unexamined Publication JP-A-2003-92124)

The above proposed electric power generation apparatus of the fuel-cell has a plurality of solid oxide fuel cells laminated in a chamber. On the other hand, in a Japanese Patent Unexamined Publication JP-A-06-196176, a device has been proposed which generates electric power by disposing a cylindrical solid oxide fuel cell in or in the vicinity of flame so that the heat of flame causes the solid oxide fuel cell to be kept at its operating temperature.

The aforementioned single chamber type fuel cell electric power generation apparatus doesn't require that strictly separating the fuel and air from each other as in the related art solid oxide fuel cell electric power generation apparatus. However, instead, it requires a hermetically sealed structure. In the single chamber type fuel cell electric power generation apparatus, a plurality of sheet-like solid oxide fuel cells are laminated and connected to each other with an interconnect material having a high heat resistance and a high electrical conductivity to raise the electromotive force so that it can be driven at high temperatures. To this end, a single chamber type fuel cell electric power generation apparatus comprising a sheet-like solid oxide fuel cell requires a large-scaled structure that adds to cost to disadvantage. In operation, the operation of the single chamber type fuel cell electric power generation apparatus must be gradually heated to a high temperature to prevent the solid oxide fuel cell from being cracked. Thus, it is troublesome and takes much time to start electricity generation.

On the other hand, the solid oxide fuel cell in the aforementioned electric power generation apparatus is a type of direct utilization of flame. This type of a fuel cell is an open type which doesn't require that the fuel cell itself is accommodated in a hermetically sealed vessel. Therefore, this fuel cell can start electricity generation in a reduced period of time and has a single structure that reduces the size, weight and cost thereof to advantage. Further, since this fuel cell allows direct utilization of flame, it can be incorporated in ordinary combustion devices, incinerators, etc. and thus has been expected to be used as an electric power supply.

However, this type of a fuel cell electric power generation apparatus has an anode electrode layer formed on the outer surface of a cylindrical solid electrolyte layer. Therefore, radical components from the flame cannot be supplied into un upper half of the anode electrode layer, making it impossible to effectively utilize the entire surface of the anode electrode layer formed on the outer surface of the cylindrical solid electrolyte layer. Thus, this type of a fuel cell has a low electricity generation efficiency.

An electric power generation apparatus having a solid oxide fuel cell having an enhanced electricity generation efficiency has been proposed (see, e.g., Japanese Patent Unexamined Publication JP-A-2004-139936). The above proposed electric power generation apparatus is shown in FIG. 4. A specific configuration of the solid oxide fuel cell C utilized herein will be described hereinafter. The solid oxide fuel cell C has a cathode electrode layer 2 formed on one side of a solid electrolyte substrate 1 and an anode electrode layer 3 formed on the other side of the solid electrolyte substrate 1 and is generally in a flat sheet form.

As mentioned above, the cathode electrode layer 2 and the anode electrode layer 3 are formed on the flat sheet-like solid electrolyte substrate 1. In this arrangement, when the anode electrode layer 3 is disposed so as to be exposed to flame f generated by a gas burner 4, the anode electrode layer 3 side becomes fuel-rich. Then, the cathode electrode layer 2 necessarily faces the atmosphere and thus is oxygen-rich. The electric power thus outputted is then drawn out from the electric power generation apparatus through a lead wire L1 attached to the cathode electrode layer 2 and a lead wire L2 attached to the anode electrode layer 3.

As compared with the aforementioned cylindrical solid oxide fuel cell, the solid oxide fuel cell C is in a flat sheet form and thus can be uniformly exposed to flame. Further, the solid oxide fuel cell C is arranged such that the anode electrode layer 3 is disposed opposed to flame, making it easy to effectively use hydrocarbons, hydrogen, radicals (e.g., OH, CH, C₂, O₂H, CH₃), etc. present in flame generated by the combustion of gas as fuel seed.

In accordance with the electric power generation apparatus having a solid oxide fuel cell described above, flame f generated by the gas burner is applied directly to the anode electrode layer 3 to act as a heat source that maintains the operating temperature of the solid oxide fuel cell C as well as a source of fuel seed required for the generation of electricity by the solid oxide fuel cell. In the foregoing description, the flame f is generated by the combustion of gas. However, it has been also proposed that the solid oxide fuel cell be applied to electric power generation apparatus in such a manner that a solid fuel is combusted to generate flame f.

As the solid oxide fuel cell for such a type of electric power generation apparatus, there may be used one having the same configuration as that of the solid oxide fuel cell C shown in FIG. 4 as it is. It suffices if the solid oxide fuel cell C can be placed on the top of the combustion device for combusting the solid fuel.

This combustion device has a combustion chamber provided therein capable of accommodating a solid fuel F and a retainer such as grating provided in the combustion chamber. As the solid fuel there is supplied a wood material, for example. The combustion device has a flame open portion provided at the upper part thereof for supporting the solid oxide fuel cell C and causing the anode electrode layer 3 to be opposed to the combustion chamber so that it is exposed to flame. The combustion device also has a solid fuel supplying open portion formed on the front surface thereof for supplying a solid fuel into the combustion chamber and an air intake open portion formed on the lower side of the solid fuel retainer for supplying air into the combustion chamber.

Besides the wood material, as the solid fuel there may be used an easily available material such as wood material chip or pellet, paraffin, olefin and alcohol. The solid fuel which has been supplied into the combustion chamber of the combustion device is then combusted to generate flame f. Flame f thus generated then hits the anode electrode layer 3 of the solid oxide fuel cell C disposed close to the open portion while external air is supplied into the cathode electrode layer 2. In this manner, radical components in flame f and oxygen in the air react with each other to generate an electromotive force between the lead wire L1 and the lead wire L2. Thus, the device acts as an electric power generation apparatus utilizing a solid oxide fuel cell.

The above proposed electric power generation apparatus which operates by direct utilization of flame has a solid oxide fuel cell disposed horizontally. The entire surface of the anode electrode layer is exposed to flame f supplied from under. An electric power generation apparatus has been proposed having two sheets of solid oxide fuel cell vertically disposed opposed to each other rather than being horizontally disposed (see, e.g., Japanese Patent Unexamined Publication JP-A-2004-311249).

The above proposed electric power generation apparatus is shown in FIG. 5. FIG. 5 depicts a longitudinal sectional view of the electric power generation apparatus. The two sheets of solid oxide fuel cell C1, C2 used herein have the same configuration as that of the solid oxide fuel cell C shown in FIG. 4. The solid oxide fuel cells C1, C2 have the same configuration and each have a cathode electrode layer 2 formed on one side of a solid electrolyte substrate 1 in a flat sheet form and an anode electrode layer 3 formed on the other side of the solid electrolyte substrate 1.

In order to incorporate the solid oxide fuel cell in an electric power generation apparatus, the solid oxide fuel cells C1, C2 are vertically disposed at a predetermined interval in such an arrangement that the anode electrode layer 3 thereof are disposed inside thereof. In this arrangement, the cathode electrode layer of the solid oxide fuel cells each face outward. The solid oxide fuel cells C1, C2 have a gas burner 4 disposed thereunder. In this arrangement, flame f generated by the gas burner 4 is supplied into the anode electrode layers 3.

When flame f is supplied into the anode electrode layers 3, the solid oxide fuel cells C1, C2 are then heated. Further, fuel seeds such as hydrocarbon, hydrogen and various radicals in flame f are supplied into the anode electrode layers 3 to cause the solid oxide fuel cells C1, C2 to generate electricity. Although not shown in FIG. 5, the solid oxide fuel cells C1, C2 each have lead wires L1, L2 attached thereto as shown in FIG. 4. When the lead wires L1, L2 of these solid oxide fuel cells are connected parallel or in series to each other, an electrical power output can be drawn out.

As mentioned above, when two sheets of solid oxide fuel cell are vertically disposed opposed to each other, the heat of flame can be efficiently used while-a sufficient amount of air can be supplied into the cathode layer by a natural convection.

Accordingly, fuel seeds produced by flame on the anode layer side and oxygen in the air on the cathode electrode layer can be effectively utilized while the solid oxide fuel cell being heated by the flame, thereby allowing electricity generation.

In accordance with the aforementioned electric power generation apparatus utilizing a solid oxide fuel cell, a gas phase fuel is normally supplied into the fuel electrode. In the case of the solid oxide fuel cell accommodated in the single chamber type electric power generation apparatus, a mixed fuel gas is supplied into the fuel electrode. In the case of the solid oxide fuel cell electric power generation apparatus which operates by direct utilization of flame, the anode electrode layer is supplied with fuel seeds of combusted gas or uncombusted gas contained in flame generated by the combustion of gas fuel. A solid fuel, if used, is combusted to generate flame that is then supplied into the anode electrode.

However, in order to produce a fuel gas contained in the mixed gas to be supplied into the device from the solid fuel as in the case of generation of electricity by the single chamber type electric power generation apparatus, it takes much time and energy that require a special producing device. In the case of the solid oxide fuel cell electric power generation apparatus which operates by direct utilization of flame, too, the gas to be combusted for the generation of flame is a gas fuel. Accordingly, the solid oxide fuel cell electric power generation apparatus which operates by direct utilization of flame is similarly disadvantageous in that a gas fuel must be supplied.

Referring to the utilization of flame generated by the combustion of a solid fuel, the solid oxide fuel cell electric power generation apparatus which operates by direct utilization of flame is advantageous over the single chamber type electric power generation apparatus in that the solid fuel can be put into gas phase in the device more simply and easily but leaves something to be desired in the stabilization of flame generated by the combustion of a solid fuel and the efficiency of supply of fuel into the fuel electrode. Further, since the solid oxide fuel cell electric power generation apparatus which operates by direct utilization of flame must have a combustion device provided therein, it leaves something to be desired in the reduction of size and thus cannot give an enhanced output of electric power.

### SUMMARY OF THE INVENTION

It is therefore an aim of the invention to provide an electric power generation apparatus utilizing a solid oxide fuel cell which is arranged to introduce a solid fuel into the interior of a solid oxide fuel cell comprising a cylindrical solid electrolyte substrate having a cathode electrode layer formed on the outer side thereof and an anode electrode layer formed on the inner side thereof and is arranged so simply as to require no sealing, making it possible to put the solid fuel in gas phase that can be used as a fuel for the fuel cell to generate electricity.

In order to achieve the aforementioned object, according to a first aspect of the invention, there is provided a solid oxide fuel cell electric power generation apparatus comprising:
a solid oxide fuel cell comprising:
   a hollow solid electrolyte substrate;
   a cathode electrode layer formed on an outer side of the substrate;
   an anode electrode layer formed on an inner side of the substrate; and
   an inner space defined by the anode electrode layer;
a heating device disposed at one open end of the inner space; and
a solid fuel disposed in the inner space,
wherein the solid fuel is heated by the heating device to supply fuel seeds into the anode electrode layer.

According to a second aspect of the invention, as set forth in the first aspect of the invention, it is preferable that the solid oxide fuel cell is arranged so that a longitudinal axis thereof directs vertically,
a retainer is provided at a lower part of the inner space in the solid oxide fuel cell, and
the heating device has a burner that generates a flame heating the solid fuel, which is retained in the inner space by the retainer.

According to a third aspect of the invention, as set forth in the first aspect of the invention, it is preferable that the solid oxide fuel cell is accommodated in a heat insulating vessel and disposed apart from an inner surface of the heat insulating vessel with a predetermined interval.

According to a fourth aspect of the invention, as set forth in the third aspect of the invention, it is preferable that a plurality of the solid oxide fuel cells are accommodated in the heat insulatinq vessel and
the solid oxide fuel cells are disposed apart from each other.

According to a fifth aspect of the invention, as set forth in the second aspect of the invention, it is preferable that the solid fuel is introduced to the inner space from an upper open end of the inner space.

As mentioned above, in the electric power generation apparatus utilizing a solid oxide fuel cell of the invention, the solid oxide fuel cell has a cathode electrode layer formed on the outer side of a hollow solid electrolyte substrate and an anode electrode layer formed on the inner side of the substrate. When a solid fuel is introduced into the inner space defined by the anode electrode layer, the solid fuel is then heated to gas phase. Thus, a fuel seed thus produced is directly supplied from the solid fuel into the anode electrode layer. Accordingly, the solid fuel can be flamelessly combusted in the inner space of the solid oxide fuel cell rather than being combusted to generate flame. As a result, the fuel seed produced from the solid fuel can be efficiently supplied into the anode electrode layer.

Further, in the electric power generation apparatus utilizing a solid oxide fuel cell of the invention, the metallic mesh is in a cylindrical form. The metallic mesh is disposed in the inner space of the solid oxide fuel cell disposed vertically. In this arrangement, the metallic mesh retains the solid fuel introduced from above in the inner space. Thus, the solid fuel is flamelessly combusted by flame supplied from under as a heating source so that it is flamelessly combusted to gas phase. As a result, in the inner space, the fuel seed produced from the solid fuel is supplied directly into the anode electrode layer. In addition to the fuel seed from flame, the fuel seed from the solid fuel can be efficiently supplied into the anode electrode layer, making it possible to raise the output of electricity generated.

### BRIEF DESCRIPTION OF THE DRAWINGS

FIG. 1 is a view showing an embodiment of implementation of the electric power generation apparatus utilizing a solid oxide fuel cell according to the invention;

FIG. 2 is a view showing a specific example of an electric power generation apparatus utilizing a solid oxide fuel cell according to the present embodiment;

FIG. 3 is a view showing an example of an electric power generation apparatus having a plurality of solid oxide fuel cells disposed therein according to the present embodiment;

FIG. 4 is a view showing an electric power generation apparatus having a solid oxide fuel cell which utilizes flame directly to operate; and

FIG. 5 is a view showing an electric power generation apparatus having two sheets of solid oxide fuel cells disposed vertically therein which each utilize flame directly to operate.

### DETAILED DESCRIPTION OF EXEMPLARY EMBODIMENTS OF THE INVENTION EMBODIMENTS

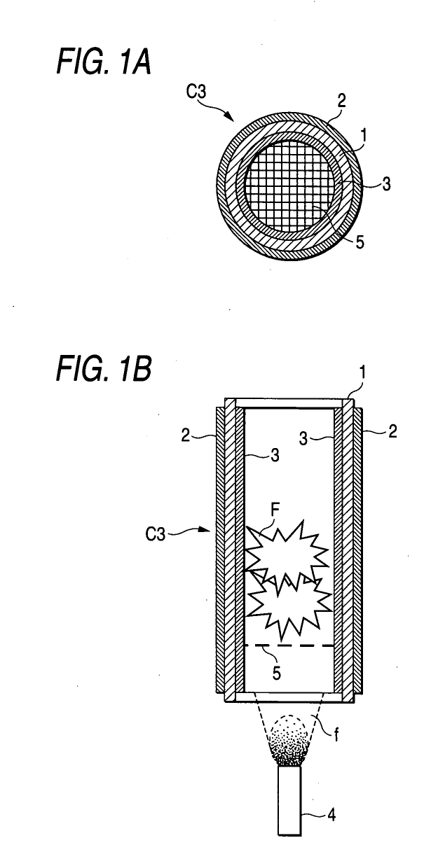

An embodiment of the electric power generation apparatus utilizing a solid oxide fuel cell according to the invention will be described hereinafter in connection with the attached drawings. FIG. 1 depicts the basic configuration of a solid oxide fuel cell electric power generation apparatus according to the present embodiment.

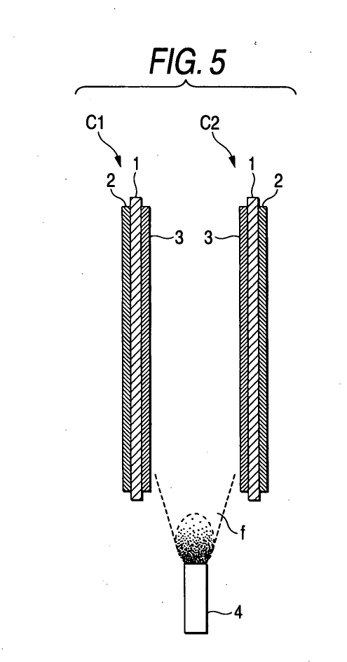

In the electric power generation apparatus shown in FIG. 5, two sheets of solid oxide fuel cells are vertically disposed so as to be opposed to each other so that the heat of flame can be efficiently used and a sufficient natural convection of air can occur on the cathode electrode layer 2 side. In this arrangement, the fuel seed produced from flame f and the oxygen in the air on the cathode electrode layer 2 side can be effectively used while heating the solid oxide fuel cell by flame f on the anode electrode layer 3 side to generate electricity.

In the electric power generation apparatus, in order to supply more fuel into the two sheets of solid oxide fuel cells C1, C2, the intensity of flame f supplied from a lower part must be raised, e.g., by raising the gas concentration to intensify the combustion of gas in the burner 4. However, the flame f thus intensified cannot sufficiently supply fuel seed onto the entire surface of the anode electrode 3 layer. As a result, the enhancement of the output of electricity that can be generated by the electric power generation apparatus is limited.

As mentioned above, on the other hand, the electric power generation apparatus utilizing a solid oxide fuel cell already proposed allows the combustion of a solid fuel in a combustion device to generate flame. The flame thus generated supplies a fuel seed into the anode electrode layer while heating the solid oxide fuel cell. The electric power generation apparatus is advantageous in that the solid fuel can be put into gas phase in the device but is disadvantageous in that the stabilization of flame generated by the combustion of the solid fuel and the enhancement of efficiency of supply of the fuel seed into the anode electrode layer are limited.

In order to solve these problems, the electric power generation apparatus according to the present embodiment is arranged such that flame is supplied from the lower part of the solid oxide fuel cells which is disposed vertically. Accordingly, the solid oxide fuel cell is heated, and a fuel seed contained in the flame is supplied into the anode electrode layer and sufficient oxygen is supplied to the cathode electrode layer side by natural convection of air. In this arrangement, in addition to the supply of a fuel seed from flame, the electric power generation apparatus of the invention allows the flame to heat the solid fuel such that it can be flamelessly combusted to generate a fuel seed that is then supplied directly into the anode electrode layer.

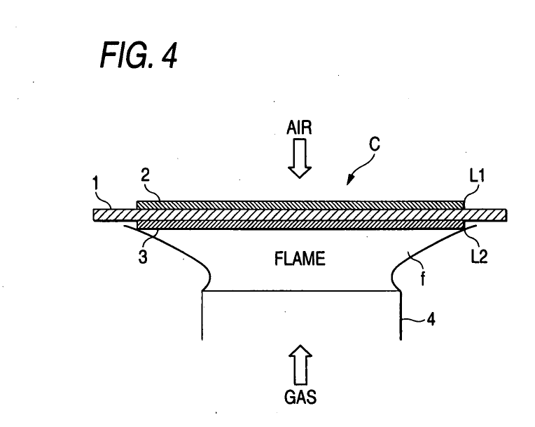

FIG. 1 depicts the basic configuration of an electric power generation apparatus according to the present embodiment. FIG. 1A depicts a transverse cross section of a solid oxide fuel cell C3. FIG. 1B depicts a vertical section of the solid oxide fuel cell C3. The solid oxide fuel cell C3 has a hollow solid electrolyte substrate 1 having a predetermined length. The substrate 1 also has a cathode electrode layer 2 formed on the outer side thereof and an anode electrode layer 3 formed on the inner side thereof. While the solid electrolyte substrate 1 is shown in a hollow form in FIG. 1, the shape of the solid electrolyte substrate 1 is not limited to cylinder. The cross section of the solid electrolyte substrate 1 may be a polygon such as rectangle. Although not shown, lead wires L1, L2 are provided for drawing electric power as in the case of the solid oxide fuel cell C shown in FIG. 4.

The cylindrical solid oxide fuel cell C3 thus formed has an inner space defined by the anode electrode layer 3. The solid oxide fuel cell C3 is supplied with flame f generated by combustion in the gas burner 4 at the lower part of the inner space. It goes without saying that even when the solid oxide fuel cell C3 is in this form as it is, the anode electrode layer 3 can be exposed to flame f which has been supplied into the inner space and thus be supplied with a fuel seed contained in the flame, making it possible to generate electricity as in the case of the electric power generation apparatus shown in FIG. 5.

In the electric power generation apparatus according to the present embodiment, a metallic mesh 5 is horizontally disposed in the inner space defined inside the solid oxide fuel cell C3. The metallic mesh 5 is prepared, e.g., from a stainless steel. A solid fuel F is introduced into the inner space at the upper end of the solid oxide fuel cell C3. The metallic mesh 5 retains the solid fuel and sifts out ash content resulted in the combustion of the solid fuel.

Referring to the vertical position of the metallic mesh 5 in the inner space, the metallic mesh 5 is preferably disposed at the lower part of the inner space as shown in FIG. 1. In the case where the metallic mesh 5 is disposed at the lower end of the inner space, the solid fuel F is exposed directly to flame F and thus is combusted to generate flame. In this case, the same results is obtained as in the aforementioned case where the gas concentration is raised to generate flame. Thus, the fuel seed from the solid fuel F cannot be effectively supplied.

On the contrary, also in the case where the metallic mesh is disposed at the upper part of the inner space, if the fuel seed is generated from the solid fuel F, the fuel seed cannot be effectively supplied into the anode electrode layer 3.

Therefore, when the metallic mesh 5 is disposed at the lower part of the inner space, i.e., at a position properly apart from the lower end of the inner space, the solid fuel F is retained in the middle part of the inner space of the solid oxide fuel cell C3. In this arrangement, with flame f supplied from the lower part as a heating source, the solid fuel F is flamelessly combusted. As a result, in the inner space, the solid fuel F is put into gas phase, and a fuel seed is supplied directly into the anode electrode layer 3. The anode electrode layer 3 presented between the lower end of the inner space and the metallic mesh 5 is supplied with the fuel seed of flame f. As the solid fuel F to be used in the electric power generation apparatus according to the present embodiment, there is preferably used an aggregated chip or pellet of wood plate, veneer, paper or wood material, which can be easily available.

The solid oxide fuel cell in the electric power generation apparatus according to the present embodiment will be described hereinafter. The solid oxide fuel cell C3 utilized herein has a solid electrolyte substrate and a cathode electrode layer and an anode electrode layer formed on the respective side of the substrate as in the case of the solid oxide fuel cells C1 and C2 shown in FIG. 5. However the solid oxide fuel cell is in a cylindrical form itself.

As a solid electrolyte substrate 1 there may be used, e.g., any known material. Examples of such a material include the following materials.
a) YSZ (yttria-stabilized zirconia), ScSZ (scandia-stabilized zirconia), zirconia-based ceramics obtained by doping these materials with Ce, Al or the like
b) Ceria-based ceramics such as SDC (samaria-doped ceria) and GDC (gadolia-doped ceria)
c) LSGM (lanthanum gallate), bismuth oxide-based ceramics

As an anode electrode layer 3 there may be used, e.g., any known material. Examples of such a material include the following materials.
d) Cermets of nickel with yttria-stabilized zirconia-based, scandia-stabilized-based or ceria-based (e.g., SDC, GDC, YDC) ceramics
e) Sintered material mainly composed of an electrically-conductive oxide (50% to 99% by weight) (As the electrically-conductive oxide there may be used nickel oxide having lithium dissolved in solid state therein or the like)
f) Metal made of platinum element, rhenium or oxide thereof incorporated in the materials d) and e) in an amount of from 1% to 10% by weight
   Particularly preferred among these materials are materials d) and e).

Due to its excellent oxidation resistance, the sintered material mainly composed of the electrically-conductive oxide e) can prevent phenomena occurring due to the oxidation of the anode layer, e.g., drop of electricity generation efficiency or incapability of electricity generation due to the rise of the electrode resistivity of the anode layer and exfoliation of the anode layer from the solid electrolyte layer. As the electrically-conductive oxide there is preferably used nickel oxide having lithium dissolved in solid state. Further, the incorporation of metal such as platinum group element or rhenium or oxide thereof in the materials d) and e) makes it possible to obtain a high electricity generation capability.

As the cathode electrode layer 2 there may be used any known material. Examples of such a material include manganate (e.g., lanthanum strontium manganite), gallium and cobaltate (e.g., lanthanum strontium cobaltate, samarium strontium cobaltate) of an element belonging to the group III such as lanthanum having strontium (Sr) incorporated therein.

The cathode electrode layer 2 and the anode electrode layer 3 each are formed by a porous material. The solid electrolyte substrate 1 in the solid oxide fuel cell C3 used in the present embodiment, too, can be in the form of porous material. As in the related art, the solid electrolyte substrate 1 in the solid oxide fuel cell used in the present embodiment may be in a dense form. However, a dense solid electrolyte substrate exhibits a low thermal shock resistance and thus can be easily cracked by sudden temperature change. In general, the solid electrolyte substrate is formed thicker than the anode electrode layer and the cathode electrode layer. Accordingly, triggered by the cracking of the solid electrolyte substrate, the related art solid oxide fuel cell is entirely cracked. As a result, the solid oxide fuel cell is completely divided into pieces.

The porous solid electrolyte substrate thus formed cannot be cracked against sudden temperature change caused by heating by the heat supplier, even against heat cycle having a great temperature difference during electricity generation. Thus, it makes possible to enhance the thermal shock resistance of the solid oxide fuel cell. As for the percent porosity of the solid electrolyte substrate, although the solid electrolyte substrate is porous, if the percent porosity falls below 10%, the resulting solid oxide fuel cell is not observed to have remarkable enhancement of thermal shock resistance when the percent porosity of the solid electrolyte substrate is 10% or more, the resulting solid oxide fuel cell is observed to have a good thermal shock resistance. When the percent porosity of the solid electrolyte substrate is 20% or more, the resulting solid oxide fuel cell is observed to have a better thermal shock resistance. This is presumably because when the solid electrolyte layer is porous, the thermal expansion caused by heating is relaxed by voids.

The solid oxide fuel cell C3 is produced by, e.g., the following method. Firstly, solid electrolyte material powders are mixed at a predetermined ratio. A green sheet is then formed by the powder mixture. The green sheet is formed into a cylindrical form. Thereafter, the green sheet is sintered to prepare a cylindrical substrate as a solid electrolyte layer. During this procedure, the kind and mixing ratio of material powders such as pore-forming material and the sintering conditions such as sintering temperature, sintering time and presintering condition can be properly adjusted to prepare solid electrolyte substrates having different percent porosities. A paste constituting the cathode electrode layer is spread over the outer surface of the substrate constituting the solid electrolyte layer, and a paste constituting the anode electrode layer is spread over the inner surface of the substrate. The substrate thus coated is then sintered to produce a solid oxide fuel cell.

The solid oxide fuel cell can have a higher durability as described below. A method for enhancing the durability of the solid oxide fuel cell has a step of embedding a metallic mesh in the cathode electrode layer 2 and the anode electrode layer 3 of the solid oxide fuel cell C3 or fixing the metallic mesh to these electrode layers. The embedding of the metallic mesh in these electrode layers is accomplished by, spreading various materials (pastes) over the solid electrolyte layer, embedding a metallic mesh in the materials thus spread, and then sintering the coated solid electrolyte layer. The fixing of the metallic mesh to these electrode layers may be accomplished by sintering the coated solid electrolyte layer with the metallic mesh bonded thereto without fully embedding the metallic mesh in the various layer materials.

As the metallic mesh there is preferably used one excellent in matching with the cathode electrode layer and anode electrode layer in which it is embedded or to which it is fixed and heat resistance. In some detail, a platinum metal or a metal made of platinum alloy in a mesh form may be used. SUS300 (in JIS: Japanese industrial standard) series stainless steels (#304, #316) or SUS400 series stainless steels (#430) may be used to advantage from the standpoint of cost.

Instead of metallic mesh, a wire metal may be embedded in or fixed to the anode electrode layer and the cathode electrode layer. The wire metal is made of the same metal as the metallic mesh. The number of the wire metals and the configuration of provision of the wire metals are not limited.

When a metallic mesh or wire metal is embedded in or fixed to the anode electrode layer or the cathode electrode layer, the solid electrolyte substrate which has been cracked by thermal history or the like can be reinforced against falling to pieces. Further, the metallic mesh or wire metal can electrically connect these pieces.

While the foregoing description has been made with reference to the case where the solid electrolyte substrate is porous, the solid electrolyte substrate of the solid oxide fuel cell according to the present embodiment may has a dense structure. In this case, the embedding of the metallic mesh or wire metal in the cathode electrode layer and the anode electrode layer is an effective method for coping with cracking due to thermal history in particular.

The metallic mesh or wire metal may be provided in both or either one of the anode electrode layer and the cathode electrode layer. Alternatively, the metallic mesh and the wire metal may be provided in combination. When the metallic mesh or wire metal is embedded in at least the anode electrode layer, the solid oxide fuel cell can continue to generate electricity without deteriorating its electricity generating capacity even if the solid electrolyte substrate is cracked by thermal history. Since the electricity generating capacity of a solid oxide fuel cell depends greatly on the effective area of the anode electrode layer as a fuel electrode, it is preferred that the metallic mesh or wire metal be provided in at least the anode electrode layer.

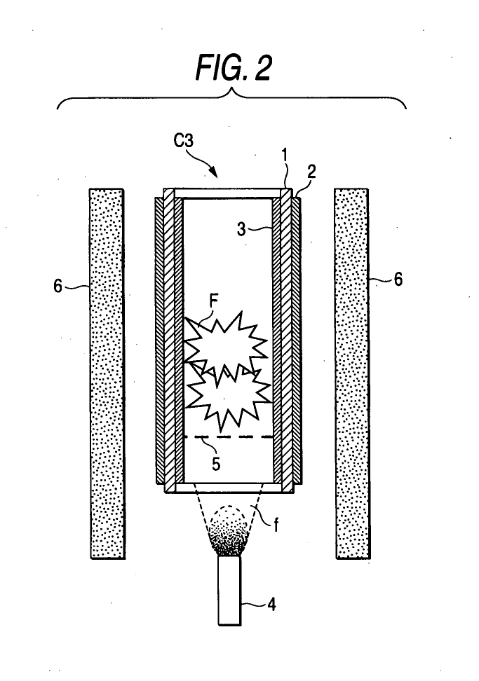

A specific example of the electric power generation apparatus utilizing a solid oxide fuel cell according to the present embodiment will be described hereinafter in connection with FIG. 2. The specific example of the electric power generation apparatus according to the present embodiment shown in FIG. 2 has a basic configuration shown in FIG. 1 and comprises its electric power generation apparatus accommodated in a heat insulating vessel 6. By properly disposing this heat insulating vessel, the heating efficiency of the solid oxide fuel cell C3 can be enhanced.

The heat insulating vessel 6 accommodates the electric power generation apparatus having the solid oxide fuel cell C3 therein. The inner surface of the heat insulating vessel 6 and the cathode electrode layer 2 of the solid oxide fuel cell C3 are disposed apart from each other at a predetermined distance. In the specific example shown in FIG. 2, the upper and lower parts of the heat insulating vessel 6 are open. In this arrangement, air can be freely supplied into the heat insulating vessel 6 from the lower open part. The space having a predetermined gap defined by the inner wall of the heat insulating vessel 6 and the cathode electrode layer 2 of the solid oxide fuel cell C3 allows efficient formation of natural convection of air that makes the cathode electrode layer 2 oxygen-rich.

Further, the upper part of the heat insulating vessel 6 is open. In this arrangement, the exhaust gas from the solid oxide fuel cell C3 and air in the natural convection are discharged upward. The upper part of the heat insulating vessel 6 does not necessarily needs to be entirely open as shown in FIG. 2 but may be covered left somewhat open wide enough to allow the exhaust gas and air in the natural convection to be released. Since it is necessary that the solid fuel F be introduced into the inner space of the solid oxide fuel cell C3, an opening/closing means for introducing the solid fuel F is provided.

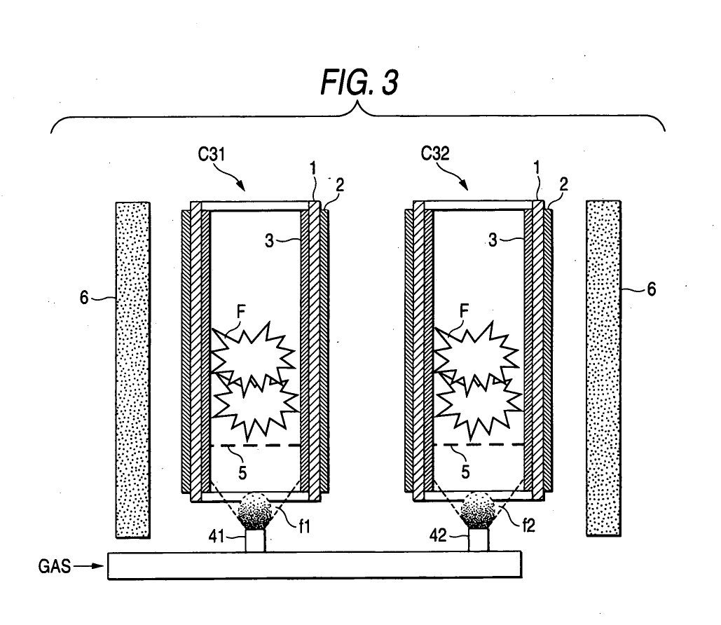

In the specific example of the electric power generation apparatus according to the present embodiment shown in FIG. 2, the solid oxide fuel cell C3 shown in FIG. 1 is accommodated in the heat insulating vessel 6. FIG. 3 depicts a case where a plurality of solid oxide fuel cells are accommodated in the heat insulating vessel 6. In FIG. 3, two sets of electric power generation apparatus each utilizing solid oxide fuel cells C31, C32 are accommodated in the heat insulating vessel 6. Where the parts are the same as those of FIG. 2, the same reference numerals are used in FIG. 3.

Flames f1, f2 to be supplied into the solid oxide fuel cells C31, C32, respectively, are generated by gas burners 41, 42 provided in the solid oxide fuel cells C31, C32, respectively. The gas burners 41, 42 are connected to a common gas feed pipe so that a premixed gas is supplied to the gas burners 41, 42 in common. Since the cathode electrode layer 2 of the solid oxide fuel cell C31 and the solid oxide fuel cell C32 are opposed to each other, the solid oxide fuel cell C31 and the solid oxide fuel cell C32 are vertically disposed at a predetermined distance from each other to assure that a natural convection of air can occur on the surface of the cathode electrode layers 2.

While two solid oxide fuel cells are shown vertically disposed in FIG. 3, three or more plural numbers of solid oxide fuel cells may be vertically disposed. In this case, adjacent solid oxide fuel cells are disposed at a predetermined distance to assure that a natural convection of air can occur on the surface of the cathode electrode layers 2.

There has been described above an embodiment of the electric power generation apparatus utilizing a solid oxide fuel cell which operates by heating a solid fuel introduced into the inner space of a cylindrical solid oxide fuel cell with flame to put the solid fuel into gas phase that gives a fuel seed which, in addition to the fuel seed contained in the flame, is used as a fuel to generate electricity. An example of the electric power generation apparatus utilizing a solid oxide fuel cell according to the invention will be described hereinafter.

### EXAMPLE

An anode electrode layer was formed on one side of a solid electrolyte substrate made of samarium-doped ceria (SDC) by a mixture of NiO and SDC containing 5% by weight of rhodium oxide and doped with lithium. A cathode electrode layer was formed on the other side of the solid electrolyte substrate by a mixture of samarium strontium cobaltite and SDC. As a current collector, a platinum mesh is used. Inside a solid oxide fuel cell having an inner diameter of 18 mm and a length of 50 mm thus prepared was then disposed a stainless steel mesh substantially perpendicular to the axis thereof.

When a flame was supplied into the solid oxide fuel cell thus prepared from the bottom thereof, a short-circuit current of about 80 mA was confirmed to flow. When a paper piece was put into the solid oxide fuel cell at the top thereof, a short-circuit current of about 120 mA at maximum was confirmed to flow.

What is claimed is:

1. A solid oxide fuel cell electric power generation apparatus comprising:
a solid oxide fuel cell comprising:
a hollow solid electrolyte substrate;
a cathode electrode layer formed on an outer side of the substrate;
an anode electrode layer formed on an inner side of the substrate; and
an inner space defined by the anode electrode layer;
a heating device disposed at one open end of the inner space; and
a solid fuel disposed in the inner space,
wherein the solid fuel is heated by the heating device to supply fuel seeds into the anode electrode layer.

2. The solid oxide fuel cell electric power generation apparatus as set forth in claim 1, wherein
the solid oxide fuel cell is arranged so that a longitudinal axis thereof directs vertically,
a retainer is provided at a lower part of the inner space in the solid oxide fuel cell, and
the heating device has a burner that generates a flame heating the solid fuel, which is retained in the inner space by the retainer.

3. The solid oxide fuel cell electric power generation apparatus as set forth in claim 1, wherein the solid oxide fuel cell is accommodated in a heat insulating vessel and disposed apart from an inner surface of the heat insulating vessel with a predetermined interval.

4. The solid oxide fuel cell electric power generation apparatus as set forth in claim 3, wherein a plurality of the solid oxide fuel cells are accommodated in the heat insulating vessel and
the solid oxide fuel cells are disposed apart from each other.

5. The solid oxide fuel cell electric power generation apparatus as set forth in claim 2, wherein the solid fuel is introduced to the inner space from an upper open end of the inner space.
